(19) United States
(12) Patent Application Publication
(10) Pub. No.: US 2025/0107665 A1
(43) Pub. Date: Apr. 3, 2025

(54) GARLIC/FOOD GRINDER

(71) Applicant: Lifetime Brands, Inc., Garden City, NY (US)

(72) Inventors: Armando Martija, Brooklyn, NY (US); Patrick Van Kirk, Flushing, NY (US)

(21) Appl. No.: 18/477,743

(22) Filed: Sep. 29, 2023

(51) Int. Cl. A47J 42/14

(52) U.S. Cl. CPC A47J 42/14

(57) ABSTRACT

A garlic or food grinder includes a top portion and a bottom portion. Ground food product is removed from the teeth of the top and bottom portions by top and bottom sliding sleeves, respectively. The bottom sliding sleeve is configured to fit over and around the top sliding sleeve during operation of the grinder when both sliding sleeves are in their retracted positions.

### BACKGROUND

### Technical Field

The present invention relates to grinders for food preparation. More particularly, it relates to a handheld garlic/food grinder.

### Description of the Related Art

Herb or food grinders that have teeth used to grind the food product have evolved over the years to the point where most are handheld and can be used relatively easily. An additional improvement includes the ability to remove the ground food product from the teeth after the grinding operation has been completed. This is particularly needed when the teeth are sharp and too close together to use a finger or even a tool to remove the ground food product.

### SUMMARY

According to one aspect, the garlic/food grinder includes a top portion having a top sleeve, a top insert configured to fit in the top sleeve, and a top grip connected to the top insert. A bottom portion includes a bottom sleeve, a bottom insert configured to fit in the bottom sleeve and a bottom grip connected to the bottom insert. The bottom sleeve has an upper portion configured to fit around the top sleeve. The top sleeve is movable relative to the top insert and the bottom sleeve is movable relative to the bottom insert.

According to other aspects, top insert includes a plurality of teeth arranged on a bottom surface thereof, and the top sleeve includes a plurality of openings corresponding in location to a location of the plurality of teeth.

In further aspects, the bottom insert includes a plurality of teeth arranged on a top surface thereof, and the bottom sleeve includes a plurality of openings corresponding in location to the plurality of teeth.

According to another aspect, a stop system is integrated into the top sleeve and top insert, such that the top sleeve has limited movement with respect to the top insert.

According to a further aspect, a separate stop system is integrated into the bottom sleeve and bottom insert, such that the bottom sleeve has limited movement with respect to the bottom insert.

In accordance with yet another aspect, the garlic/food grinder includes a first portion having a first insert and a first sleeve, and a a second portion having a second insert and a second sleeve. The second sleeve having an upper portion configured to fit around the first sleeve when the grinder is in a closed position. The first sleeve is movable relative to the first insert and the second sleeve is movable relative to the second insert.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1A is a perspective view of a garlic grinder according to an embodiment;

FIG. 1B is an elevational view of the garlic grinder according to an embodiment;

FIG. 1C is a cross-sectional view of the garlic grinder take along lines 1C-1C of FIG. 1A;

FIG. 2 an exploded perspective view of the garlic grinder according to an embodiment;

FIG. 3A is a perspective view of the top insert of the garlic grinder according to an embodiment;

FIG. 3B is a perspective view of the top sleeve of the garlic grinder according to an embodiment;

FIG. 4A is a perspective view of the bottom sleeve of the garlic grinder according to an embodiment;

FIG. 4B is a perspective view of the bottom insert of the garlic grinder according to an embodiment;

FIG. 4C is a cross-sectional view of the bottom sleeve, according to an embodiment;

FIG. 5 is a perspective view of the garlic grinder with the top and bottom sleeves in the grinding position according to an embodiment; and

FIG. 6 is a perspective view of the garlic grinder with the top and bottom sleeves in the dispensing positions.

### DETAILED DESCRIPTION

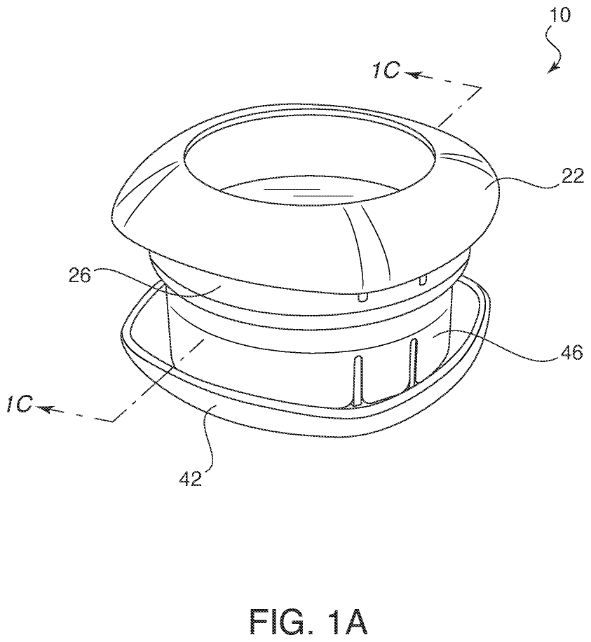

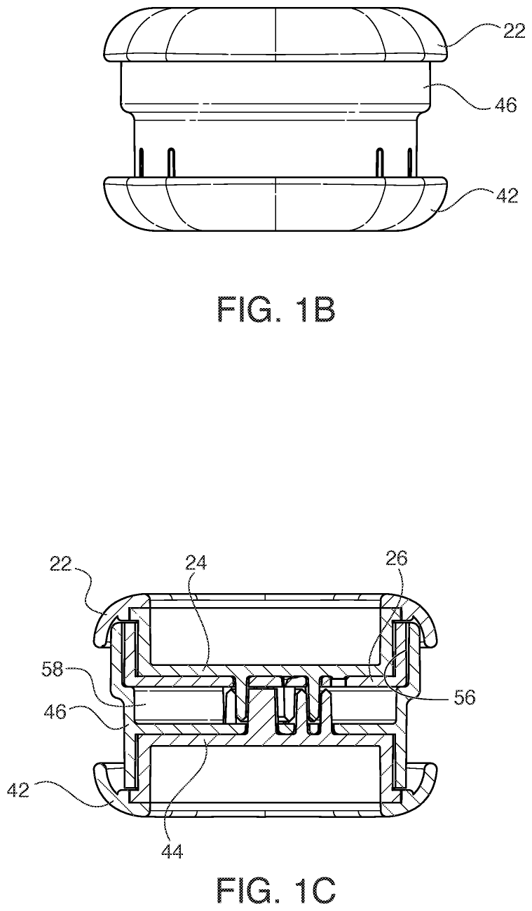

Referring to FIGS. 1A-1C, the garlic grinder 10 includes a top grip 22, a top insert 24 and a top sleeve 26 slidably arranged over the top insert 24. The grinder 10 further includes a bottom grip 42, a bottom insert 44 and a bottom sleeve 46 slidably arranged over the bottom insert 44. The use of “top” and “bottom” throughout this specification is exemplary, and it will be appreciated that these can be reversed without departing from the intended scope of the present principles. Further, as used herein “top” and “bottom” can be substituted with “first” and “second”, respectively.

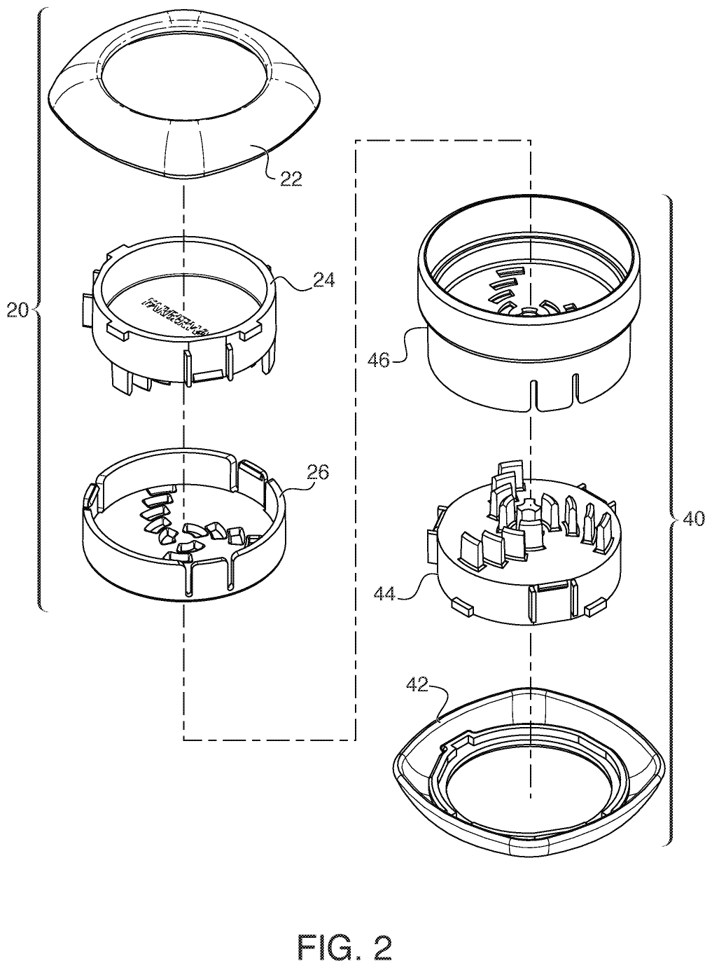

Referring to FIG. 2, grinder 10 is comprised or made up of two parts, an upper part 20, and a lower part 40. As mentioned above, the upper part 20 consists of the top grip 22, the top insert 24 and the top sleeve 26 slidably arranged over the top insert 24. The lower part 40 consists of the bottom grip 42, the bottom insert 44 and the bottom sleeve 46 movably or slidably arranged over the bottom insert 44.

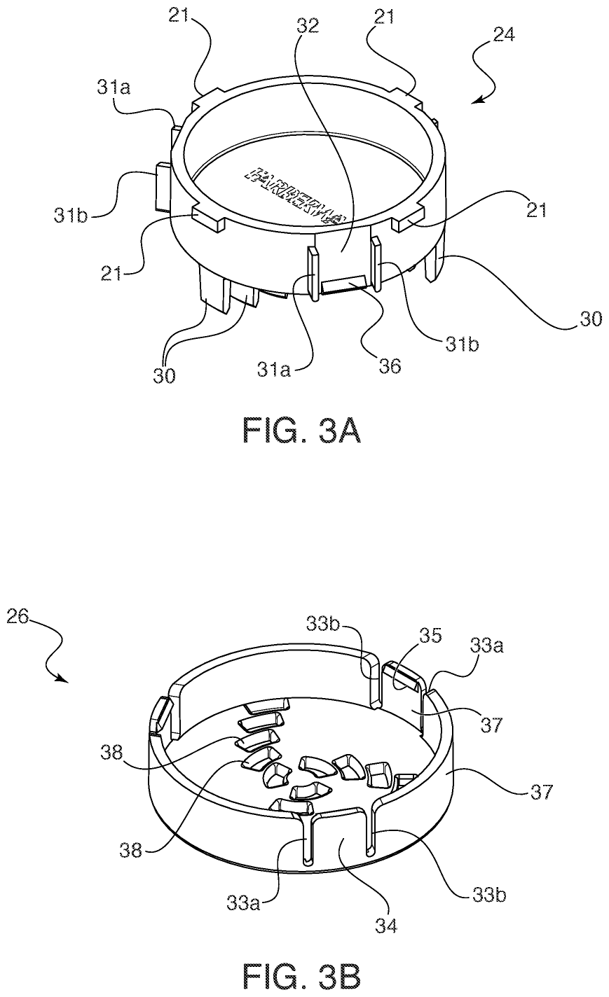

FIG. 3A shows the details of the top insert 24 according to an implementation of the invention. In this example, the top insert 24 is shown having a round or circular configuration, however other geometric shapes may also be employed without departing from the intended scope of this disclosure.

As shown top insert 24 includes tabs 21 along an upper edge of the same and spaced from each other. These tabs 21 are configured to enable the top insert to be attached to the top grip 22. In operation, the top insert 24 is fixedly attached to the top grip 22. A plurality of teeth 30 are arranged on a bottom surface of the top insert 24. The teeth 30 are preferably arranged in a pattern such that they mesh with, yet do not interfere with, the bottom insert teeth 60 when the grinder is in an operable position and during use.

In accordance with one implementation, a pair of spaced rails 31A, 31B are arranged on an outer circumference or outer surface of the top insert 24. In between each pair of spaced rails 31A and 31B is a protrusion or stop 36 that, as will be described below, is part of the slidable or movable engagement between the top insert 24 and the top sleeve 26. In this exemplary embodiment, three (3) pairs of spaced rails are shown. It is to be understood that other embodiments can include as little as one rail, or as many rails as needed to maintain the sliding engagement between the top insert 24 and the top sleeve 26.

FIG. 3B shows the top sleeve 26 according to the exemplary embodiment. In this example, top sleeve 26 has a circular geometric shape configured to match the geometric shape of the top insert so the two work together. As noted above, in this exemplary embodiment the geometric shape is circular, but could be other geometric shapes as well depending on desired design and appearance.

The top sleeve 26 includes upwardly extending walls 37 all around the same, where paired slots 33A, 33B form a tab 34 between the same. A protrusion or stop 35 is positioned at the top inside surface of each of the tabs 34 formed by the paired slots 33A, 33B. A plurality of holes 38 are provided in the bottom surface of the sleeve 26 and are positioned and patterned to receive the teeth 31 of the top insert. As is shown and described below, the pairs slots 33A, 33B are configured to receive the paired rails 31A, 31B such that the top sleeve 26 is movable or slidable along the paired rails, respectively, while also being maintained in position by the paired slots 33A, 33B. During operation, the top sleeve 26 is positioned around the top insert 24 such that the protrusion/stop 35 of the top sleeve and the protrusion/stop 36 of the top insert are positioned such that when the sleeve 26 is pulled downward while holding the top grip 22 with insert 24 stationary (or the top insert 24 attached to the top grip 22 is pulled upward while holding the top sleeve stationary), the stop 35 will ultimately hit stop 36, and limit the sliding motion with respect to the top insert 24 and top sleeve 26.

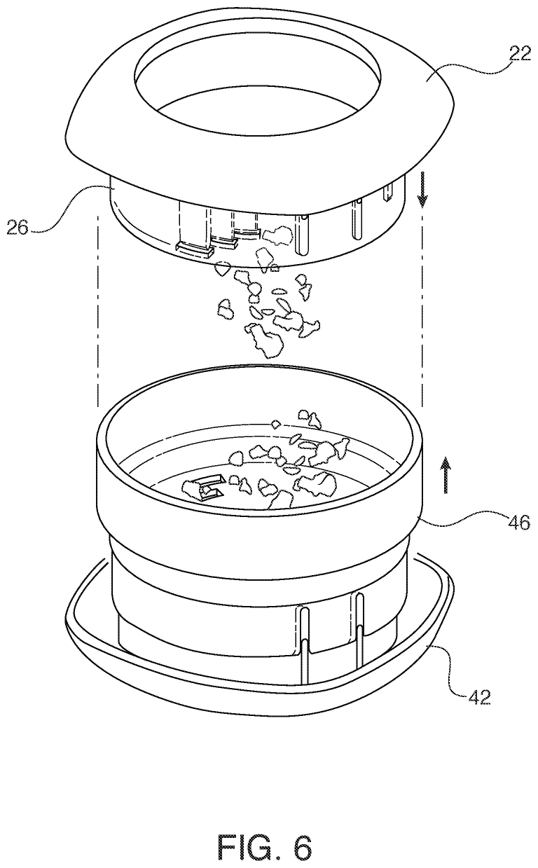

The movement of the top sleeve 26 relative to the top insert 24, and the holes 38 in the bottom surface of the top sleeve 26 allows for the clearing of food product from between the teeth 30 of the top insert 24 after the grinding action has occurred (See FIGS. 5 and 6).

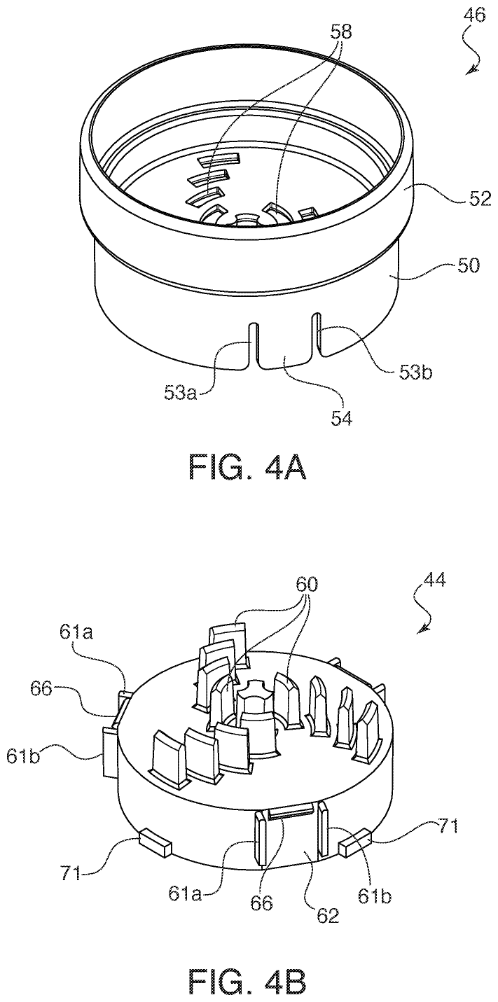

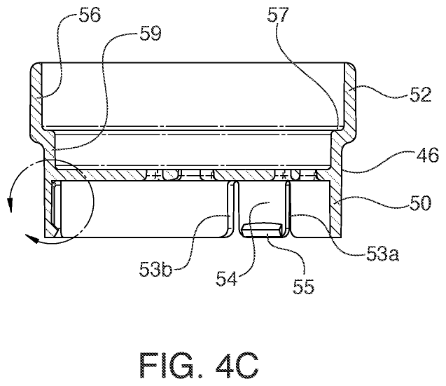

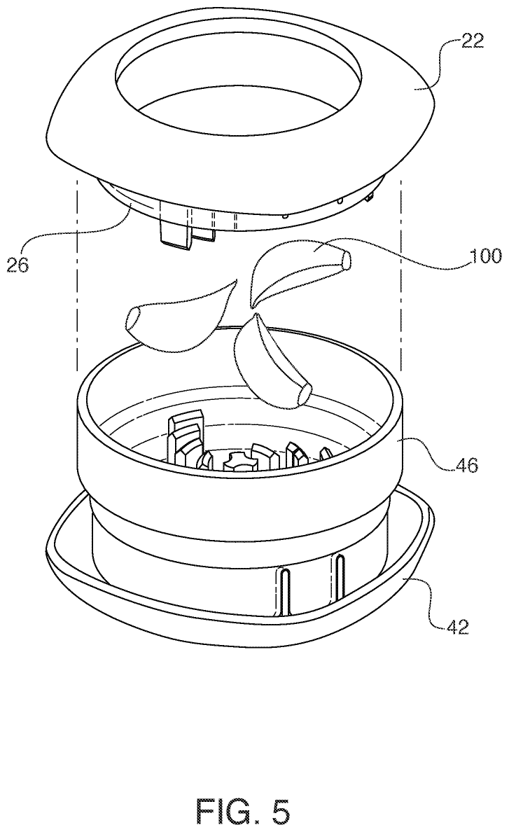

FIGS. 4A and 4C show the bottom sleeve 46 having a lower portion 50 that is smaller in diameter than an upper portion 52. The lower portion 50 includes at least one pair of slots 53A, 53B forming at least one tab 54 therebetween. A stop 55 is positioned on the inside surface at the lower end of each tab 54. In the exemplary embodiment, three pairs of slots 53A, 53B, are utilized. The walls 56 of the larger diameter upper portion 52 are configured to fit around the top sleeve 26 when the top (20) and bottom (40) portions are brought together for grinding, while area 58 is a space configured to receive the food product and the grinding teeth 30 and 60 of the upper portion 20 and lower portion 40, respectively. (See FIG. 1C). At the bottom of the area 58 is a surface having holes 68 that correspond in size and pattern to the teeth 60 on the bottom insert 44. The walls 56 and area 59 are delineated by a ledge or step 57.

FIG. 4B shows the details of the bottom insert 44 according to an implementation of the invention. In this example, the bottom insert is shown having a round or circular configuration, however as noted above with respect to the bottom sleeve 46, other geometric shapes may also be employed without departing from the intended scope of this disclosure.

As shown, bottom insert 44 includes tabs 71 along a bottom edge of the same and spaced from each other. These tabs 71 are configured to enable the bottom insert to be attached to the bottom grip 42. In operation, the bottom insert 44 is fixedly attached to the bottom grip 42. A plurality of teeth 60 are arranged on a top surface of the bottom insert 44. The teeth 60 are preferably arranged in a pattern such that they mesh with, yet do not interfere with, the top insert teeth 30 when the grinder is in the operable position and during use.

In accordance with one implementation, a pair of spaced rails 61A, 61B are arranged on an outer circumference or surface of the bottom insert 44. In between each pair of spaced rails 61A and 61B is a protrusion or stop 66 that, as will be described below, is part of the slidable or movable engagement between the bottom insert 44 and the bottom sleeve 46. In this exemplary embodiment, three (3) pairs of spaced rails are shown. It is to be understood that other embodiments can include as little as one rail, or as many rails as needed to maintain the sliding engagement between the bottom insert 44 and the bottom sleeve 46. During operation, the bottom sleeve 46 is positioned around the bottom insert 44 such that the protrusion/stop 55 of the bottom sleeve and the protrusion/stop 66 of the bottom insert are positioned such that when the sleeve 46 is pulled upward while holding the bottom grip 42 with insert 44 stationary (or the bottom insert 44 attached to the bottom grip 42 is pulled downward while holding the bottom sleeve 46 stationary), the stop 55 will ultimately hit stop 66, and limit the sliding motion with respect to the bottom insert 44 and bottom sleeve 46.

The movement of the bottom sleeve 46 relative to the bottom insert 44, and the holes 58 in the inner surface of the bottom sleeve 46 allows for the clearing of food product from between the teeth 60 of the bottom insert 44 after the grinding action has occurred (See FIGS. 5 and 6). In the representation shown in FIG. 4C, it will be appreciated that the teeth 60 on the upper surface of the bottom insert 44 are not shown.

FIG. 5 shows a food product such as garlic 100 placed into the opening of the bottom sleeve 46 with the teeth 60 of the bottom insert exposed (i.e., the sleeve 46 is retracted to its lower most position relative to the grip 42). The upper sleeve 26 is also retracted to its lowest position relative to the top grip 22, such that the teeth 30 are exposed. In operation, the top portion 20, and bottom portion 40 are brought together such that the upper portion 52 of the bottom sleeve 46 fits around the top sleeve 26 (see FIG. 1C). The grips 22 and 42 are then rotated relative to each other (often in opposing directions), or one grip 22 or 42 is rotated while the other 42 or 22, respectively, is maintained in a stationary position by the user. Once the grinding is complete, the top portion 20 and bottom portion 40 are separated from each other.

Referring to FIG. 6, once the top portion 20 and bottom portion 40 are separated from each other, the top sleeve 26 can be slid or moved away from the top grip 22 so as to clear the ground food product from the teeth 30 of the top insert 24, and the bottom sleeve 46 is can be slid or moved away from the bottom grip 42 so as to remove the ground food product from the teeth 60 of the bottom insert 44. As will be appreciated, the movement of the sleeves 26 and 46 can be performed over a bowl or surface to receive the ground food product for further food preparation.

It should also be understood that the example embodiments disclosed and taught herein are susceptible to numerous and various modifications and alternative forms. Thus, the use of a singular term, such as, but not limited to, “a” and the like, is not intended as limiting of the number of items. Furthermore, the naming conventions for the various components, functions, parameters, thresholds, and other elements used herein are provided as examples, and can be given a different name or label. The use of the term “or” is not limited to exclusive “or” but can also mean “and/or”.

While particular embodiments and applications of the present disclosure have been illustrated and described, it is to be understood that the present disclosure is not limited to the precise construction and compositions disclosed herein and that various modifications, changes, and variations can be apparent from the foregoing descriptions without departing from the invention as defined in the appended claims.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that the scope of the patent should not be limited to the described embodiments but rather should be limited only by the spirit and scope of the following claims.

What is claimed is:

1. A food grinder comprising:
a top portion having a top sleeve, a top insert configured to fit in the top sleeve, and a top grip connected to the top insert;
a bottom portion having a bottom sleeve, a bottom insert configured to fit in the bottom sleeve and a bottom grip connected to the bottom insert, the bottom sleeve having an upper portion configured to fit around the top sleeve;
wherein the top sleeve is movable relative to the top insert and the bottom sleeve is movable relative to the bottom insert.

2. The food grinder according to claim 1, where in the top insert includes a plurality of teeth arranged on a bottom surface thereof, and the top sleeve includes a plurality of openings corresponding in location to a location of the plurality of teeth.

3. The food grinder according to claim 1, wherein the bottom insert includes a plurality of teeth arranged on a top surface thereof, and the bottom sleeve includes a plurality of openings corresponding in location to the plurality of teeth.

4. The food grinder according to claim 1, further comprising a stop system on the top sleeve and top insert, such that the top sleeve has limited movement with respect to the top insert.

5. The food grinder according to claim 4, further comprising a separate stop system on the bottom sleeve and bottom insert, such that the bottom sleeve has limited movement with respect to the bottom insert.

6. A food grinder comprising:
a first portion having a first insert and a first sleeve,
a second portion having a second insert and a second sleeve, the second sleeve having an upper portion configured to fit around the first sleeve when the grinder is in a closed position;
wherein the first sleeve is movable relative to the first insert and the second sleeve is movable relative to the second insert.

7. The food grinder according to claim 6, where in the first insert includes a plurality of teeth arranged on a bottom surface thereof, and the first sleeve includes a plurality of openings corresponding in location to a location of the plurality of teeth.

8. The food grinder according to claim 6, wherein the second insert includes a plurality of teeth arranged on a top surface thereof, and the second sleeve includes a plurality of openings corresponding in location to the plurality of teeth.

9. The food grinder according to claim 6, further comprising a stop system on the first sleeve and first insert, such that the first sleeve has limited movement with respect to the first insert.

10. The food grinder according to claim 9, further comprising a separate stop system on the second sleeve and second insert, such that the second sleeve has limited movement with respect to the second insert.

11. The food grinder according to claim 6, further comprising a first grip configured to be fixedly attached to the first insert.

12. The food grinder according to claim 6, further comprising a second grip configured to be fixedly attached to the second insert.
